(19) United States
(12) Patent Application Publication
(10) Pub. No.: US 2024/0378805 A1
(43) Pub. Date: Nov. 14, 2024

(54) 3D ROAD SCENE GENERATION SYSTEM AND 3D ROAD SCENE GENERATION METHOD FOR SIMULATING A REAL ENVIRONMENT

(71) Applicant: UNIWILL TECHNOLOGY INC., Taipei City (TW)

(72) Inventors: Chun-Cheng CHEN, TAIPEI CITY (TW); Ting-Hung LEE, TAIPEI CITY (TW); Shao-Hong YANG, TAIPEI CITY (TW); Tzu-An KUO, TAIPEI CITY (TW)

(21) Appl. No.: 18/196,895

(22) Filed: May 12, 2023

(51) Int. Cl. G06T 17/05; G06T 19/20

(52) U.S. Cl. CPC G06T 17/05; G06T 19/20; G06T 2219/2016

(57) ABSTRACT

A 3D road scene generation system (1) for simulating a real environment is presented. The 3D road scene generation system (1) generates 3D topographic data (41) based on a topographic map (40) , generates 3D route data including a target route (43) based on road network data (42) , generates 3D landscape data (44) based on landscape data, and executes an integrating process on these data to generate the 3D road scene data (46, 49) for presenting terrain changes and scenery along the target route (43) .

### BACKGROUND OF THE DISCLOSURE

### Technical Field

The present disclosure relates to 3D road scenes, particularly to a system and a method for simulating the real environment of 3D road scenes.

### Description of Related Art

The related art of simulated real environments, such as a marathon of simulated real roads, driving or riding games, or the like, play the stream videos showing the real road in the game and provides a user with experiences of moving in a real-world-like environment by the road data.

However, the stream video service costs a large amount of bandwidth and occupies a large number of storage spaces. Once the bandwidth or the storage space is not enough, the service is interrupted and user experiences are worse.

In addition, the quality of the streaming video is affected by the surrounding object, passersby, weathers, or other factors when the provider shoots the videos. It is one reason that good streaming video is difficult to produce.

In addition, the streaming video only has a fixed field of view (i.e., the field of view of the camera), and the field of view cannot be changed at will.

In addition, there is no relationship between the streaming video and the road data (e.g., slops), so it is difficult to provide the user with the experience of going uphill or downhill.

Therefore, problems exist in the related art of simulated real environment, so more effective solutions to the problems are needed to be proposed.

### SUMMARY OF THE DISCLOSURE

The present disclosure provides a 3D road scene generation system and a 3D road scene generation method for simulating a real environment to automatically generate the 3D road scenes with variable angles of view based on the data of the real environment.

In one embodiment, a 3D road scene generation system for simulating a real environment is provided. The 3D road scene generation system for simulating the real environment includes a terrain feature module, a road network data module, a basic object module, and an integration module. The terrain feature module is configured to generate 3D topographic data of a target area based on a topographic map received from a terrain server. The road network data module is configured to generate 3D route data of the target area based on road network data received from a road network server, wherein the 3D route data comprises a target route of the target area. The basic object module is configured to generate 3D landscape data of the target area based on landscape data received from a landscape server. The integration module is configured to perform an integrating process to the 3D topographic data, the 3D route data, and the 3D landscape data to generate 3D road scene data, wherein the 3D road scene data is configured to present terrain changes and scenery along the target route.

In one embodiment, a 3D road scene generation method for simulating a real environment includes a) generating 3D topographic data of a target area based on a topographic map received from a terrain server: b) generating 3D route data of the target area based on road network data received from a road network server, wherein the 3D route data comprises a target route of the target area: c) generating 3D landscape data of the target area based on landscape data received from a landscape server: and d) performing an integrating process to the 3D topographic data, the 3D route data, and the 3D landscape data to generate 3D road scene data, wherein the 3D road scene data is used to present terrain changes and scenery along the target route.

The present disclosure automatically generates the 3D road scenes of the simulated real environment and provides the users with an immersive experience as if they were moving in the real environment.

### BRIEF DESCRIPTION OF THE DRAWINGS

FIG. 1 is a block diagram of a 3D road scene generation system in accordance with one embodiment of the present disclosure.

FIG. 2 is an architecture diagram of the 3D road scene generation system connecting to servers in accordance with one embodiment of the present disclosure.

FIG. 3 is a flowchart illustrating a 3D road scene generation method in accordance with one embodiment of the present disclosure.

FIG. 4 is a flowchart illustrating the 3D road scene generation method in accordance with one embodiment of the present disclosure.

FIG. 5 illustrates an example of a topographic map in accordance with one embodiment of the present disclosure.

FIG. 6 illustrates an example of a 3D topographic map in accordance with one embodiment of the present disclosure.

FIG. 7 illustrates an example of 3D route data in accordance with one embodiment of the present disclosure.

FIG. 8 illustrates an example of 3D landscape data in accordance with one embodiment of the present disclosure.

FIG. 9 illustrates an example of 3D road scene data in accordance with one embodiment of the present disclosure.

FIG. 10 illustrates an example of the 3D road scene data after adjusting in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The present disclosure provides a 3D road scene generation system and a 3D road scene generation method for simulating a real environment that receives data of the real environment and transforms the data into 3D road scene data of the simulated real environment.

Compared with the related art of using video stream services for simulating a real environment, the present disclosure generates 3D road scene data, and the 3D road scene data is downloaded to an experience device (e.g., a client computer device 32 mentioned below) without consuming a large number of bandwidths, so the possibility that the simulation service might be disconnected is eliminated.

Furthermore, because the 3D road scene data is stored as vector data types, it doesn't occupy too much storage space.

Furthermore, because the 3D road scene data excludes all the environmental factors (a surrounding object, a crowd of people, a weather condition, and so on) and the environmental factors may be changed based on the demands (such as changing the weather condition, the crowd of people, the scenery and objects along the road, and so on), the user experience is improved.

Furthermore, the user changes the field of view by using the 3D road scene data while experiencing the service and sees the scenery in different fields of view, so the user experience is improved.

Furthermore, the association among 3D route data, 3D topographic, and 3D landscape data is applied through the coordinates, so the simulation service presents the slope difference. Accordingly, the user experience is improved.

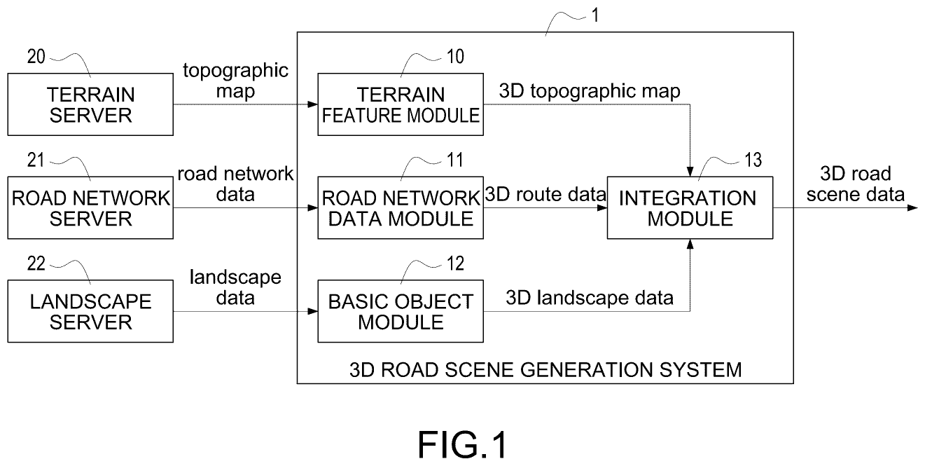

Reference is made to FIG. 1. FIG. 1 is a block diagram of a 3D road scene generation system in accordance with one embodiment of the present disclosure.

The 3D road scene generation system 1 includes a terrain feature module 10, a road network data module 11, a basic object module 12, and an integration module 13.

The 3D road scene generation system 1 may be but is not limited to a general-purpose computer system, such as a tablet computer, a personal computer, a notebook computer, a server, a cloud computing platform, or other computer systems.

The terrain feature module 10 receives a topographic map from a terrain server 20 and generates 3D topographic data based on the topographic map.

In one embodiment, the terrain server 20 may be but is not limited to the server of websites like “Tangram Heightmapper”, “terrain.party”, or “USGS EarthExplorer”. The terrain feature module 10 automatically receives the topographic map through the application programming interface (API) provided by the websites above.

The road network data module 11 receives road network data from a road network server 21 and generates 3D route data based on the road network data.

In one embodiment, the road network server 21 may be but is not limited to the server of websites like “MAPBOX” or “Google Map”. The road network data module 11 automatically receives the road network data through the API provided by the websites above.

The basic object module 12 receives landscape data from a landscape server 22 and generates 3D landscape data based on the landscape data.

In one embodiment, the landscape server 22 may be but is not limited to the server of websites like “MAPBOX” or “Open Street Map”. The basic object module 12 automatically receives the landscape data through the API provided by the websites above.

The integration module 13 integrates the 3D topographic data, the 3D route data, and the 3D landscape data into 3D road scene data and releases the 3D road scene data to other devices.

It should be noted that the modules 10 to 13 above are connected with each other through electrical means or communicative means and may be hardware modules (such as the electronic circuit module, integrated circuit module, or System on Chip (SoC)), software modules, or the mixture of hardware modules and software modules, and it is not limited herein.

When the modules 10 to 13 are software modules (such as the firmware, the operation system, or the application), a storage device (not shown in figures) of the 3D road scene generation system 1 includes a non-transitory computer-readable storage medium. The non-transitory computer-readable storage medium stores multiple computer programs respectively corresponding to the modules 10 to 13, and each of the computer programs stores the computer-executable program codes. After the processor (not shown in figures) of the 3D road scene generation system I executes the program codes, the processing functions of the modules 10 to 13 are implemented.

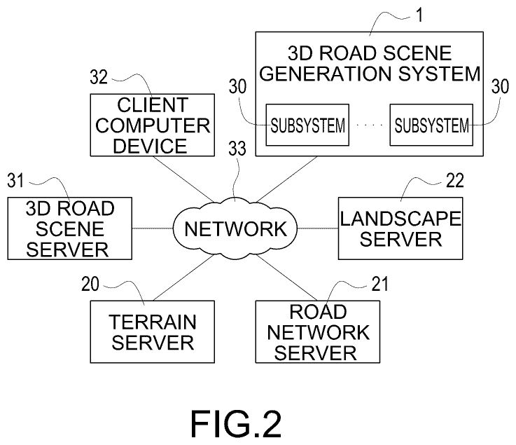

Reference is made to FIG. 1 and FIG. 2. FIG. 2 is an architecture diagram of the 3D road scene generation system connecting to servers in accordance with one embodiment of the present disclosure.

In one embodiment, the 3D road scene generation system 1 includes a plurality of subsystems 30, such as a plurality of general-purpose computer systems. The plurality of subsystems 30 connect to a network 33 (such as the Internet or the Intranet) and respectively perform the modules 10 to 13.

For example, there are four subsystems 30 in the 3D road scene generation system 1. A first subsystem includes the terrain feature module 10 implemented by the corresponding software module stored therein or implemented by the hardware module. A second subsystem includes the road network data module 11, a third subsystem includes the basic object module 12, and a fourth subsystem includes the integration module 13.

In one embodiment, the 3D road scene generation system 1, the terrain server 20. the road network server 21, and the landscape server 22 connect to the same network 33 (such as the Internet) to implement the communication.

In one embodiment, the 3D road scene generation system 1 includes a 3D road scene server 31 connecting to the network 33. The 3D road scene server 31 is configured to store the 3D road scene data being generated.

In one embodiment, the 3D road scene server 31 is configured to store a plurality of default 3D road scene data of a plurality of default areas. When receiving a road scene request of any default area from a client computer device 32, the 3D road scene server 31 transmits the default 3D road scene data of the indicated default area as feedback through the network 33 to the client computer device 32 as the 3D road scene data of a target area of a game.

In one embodiment, the default 3D road scene data of each default area includes a plurality of 3D grids. The plurality of 3D grids respectively corresponds to a plurality of sub-areas of each default area.

Furthermore, when any default 3D road scene data is downloaded or processed, the 3D grid is regarded as the minimum downloading or processing unit and the 3D road scene data is downloaded or processed in batches in order to reduce the processing resource or the bandwidth usage.

In one embodiment, the user may operate the client computer device 32 (such as the VR device, the smartphone, the tablet computer, the gaming machine, and the like) to install the indicated application and make the client computer device 32 connect to the 3D road scene server 31 by the application to transmit the road scene request for downloading all or indicated 3D road scene data.

After downloading the 3D road scene data, the user may participate in movements or sports in the simulated real environment.

For example, the user may walk around or exercise at home (e.g., by using the treadmill or bicycle trainer). The client computer device 32 collects the sports information of the user (e.g., moving speeds and moving directions), decides the current position of the user in the 3D road scene data according to the sports information of the user, and displays the road scene of the current position.

In another embodiment, when the user operates the client computer device 32 to change the field of view (such as turning around or turning to some direction), the client computer device 32 collects the turning angle information of the user (such as angle degrees of the turning angle), decides the current angle of view of the user in the 3D road scene data according to the turning angle information of the user, and displays the road scene of the current angle of view.

Accordingly, the user may participate in the immersive experience as if he/she moves in a real environment.

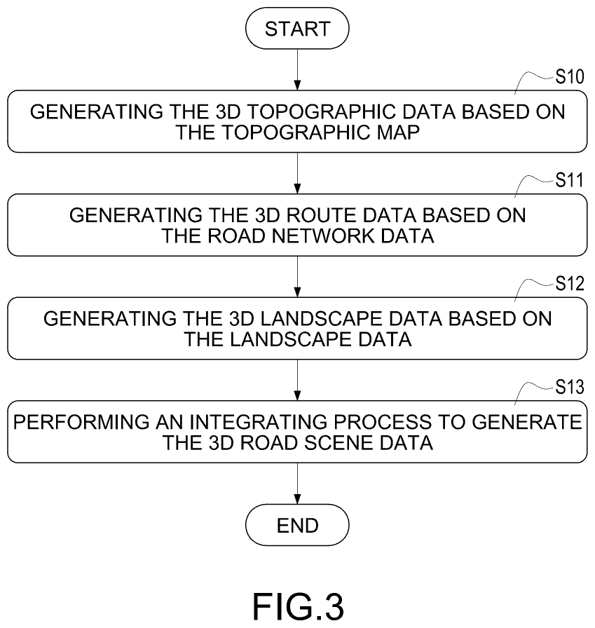

Reference is made to FIGS. 1 to 3. FIG. 3 is a flowchart illustrating a 3D road scene generation method in accordance with one embodiment of the present disclosure. Each embodiment of the 3D road scene generation method of the present disclosure is implemented by the 3D road scene generation system 1.

In one embodiment, the 3D road scene generation method includes steps S10 to S13. Steps S10 to S13 are performed to automatically generate 3D landscape data of a target area. The range of the target area is determined based on the movement amount, such as a running range, a riding range, or a driving range in the game.

In step S10: the terrain feature module 10 receives the topographic map of the target area from the terrain server 20 and generates the 3D topographic data of the target area based on the topographic map.

In step S11: the road network data module 11 receives the road network data from the road network server 21 and generates the 3D route data of the target area based on the road network data.

Furthermore, the road network data module 11 sets a target route of the target area in the 3D route data. The target route may be the route that the user participates in the game.

In step S12: the basic object module 12 receives the landscape data from the landscape server 22 and generates the 3D landscape data of the target area based on the landscape data.

In step S13: the integration module 13 performs an integrating process to the 3D topographic data, the 3D route data, and the 3D landscape data to generate the 3D road scene data.

It should be noted that the 3D road scene data generated by the integration module 13 is used to present terrain changes and scenery along the target route.

Therefore, when the user virtually moves along the target route, he/she may experience terrain height changes and road scene changes along the target route.

In one embodiment, the integration module 13 splits the 3D road scene data into a plurality of 3D grids and takes the 3D grids as the processing unit, so the processing speed is increased and the processing resource demand is decreased. The plurality of 3D grids respectively corresponds to the plurality of sub-areas of the target area.

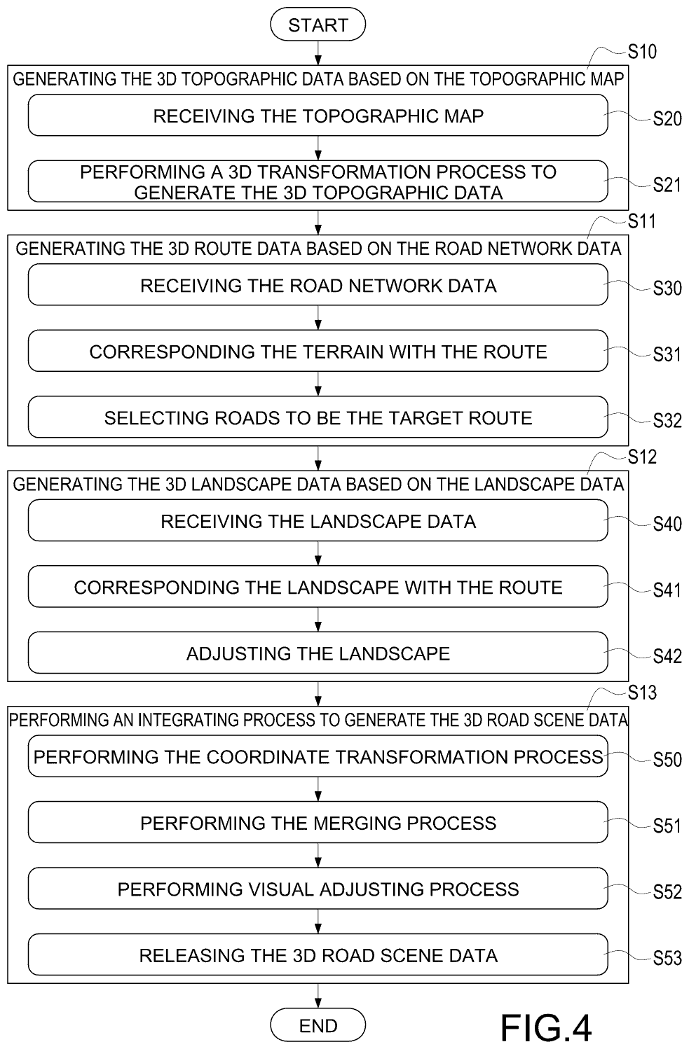

Reference is made to FIGS. 1 to 4. FIG. 4 is a flowchart illustrating the 3D road scene generation method in accordance with one embodiment of the present disclosure.

In one embodiment, step S10 includes steps S20 to S21.

In step S20: the terrain feature module 10 receives the topographic map from the terrain server 20 through the API provided by the terrain server 20.

In one embodiment, the topographic map is a 2D gray image, and a plurality of values of a plurality of pixels of the topographic map is used to indicate the heights of the corresponding geographic heights.

In one embodiment, the topographic map is an aerial image or a geomorphological map. The pixels of the topographic map are corresponding to a different geographic locations (such as the GPS coordinates) and the values of the pixels indicate the geographic height.

In step S21: the terrain feature module 10 performs a 3D transformation process to the received topographic map to generate the 3D topographic data based on the 3D graphics coordinate system. In particularly, the 3D transformation process is performed to generate multiple heights with multiple values on multiple positions in the 3D topographic data which correspond to the multiple pixels of the topographic map.

In one embodiment, the 3D transformation process includes a coordinate transformation process. The coordinate transformation process transforms the topographic map from the global positioning coordinate system (such as the GPS coordinate system) into the 3D graphics coordinate system of the 3D cartography software (such as the Unity 3D coordinate system).

In one embodiment, the 3D transformation process includes a terrain reconstruction process. The terrain reconstruction process builds the terrain with the corresponding heights in the 3D graphics coordinate system based on each pixel of the topographic map and regards the terrain to be the 3D topographic data.

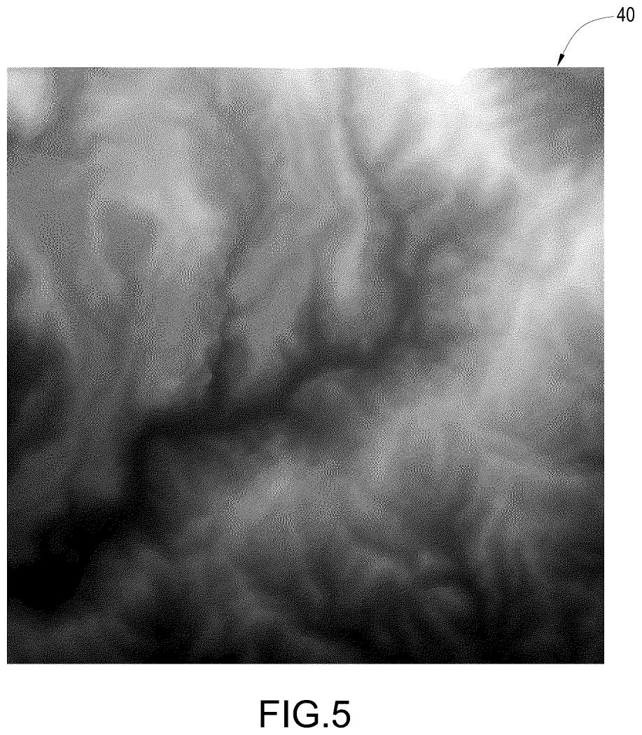

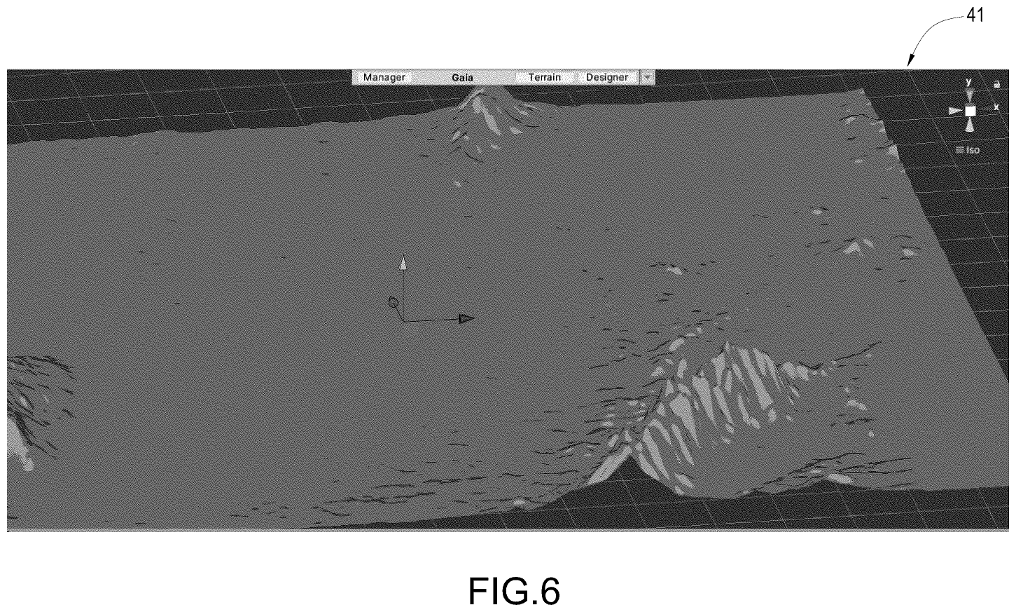

Reference is made to FIGS. 5 and 6. FIG. 5 illustrates an example of a topographic map in accordance with one embodiment of the present disclosure. FIG. 6 illustrates an example of a 3D topographic map in accordance with one embodiment of the present disclosure.

The topographic map 40 is an 8-bit gray aerial image.

The smaller the pixel value of the topographic map 40 (such as close to zero) is, the lower the height of the position is, and the lower terrain of the corresponding position in the 3D topographic data 41 may be generated.

The larger the pixel value of the topographic map 40 (such as close to 255) is, the higher the height of the position is, and the higher terrain of the corresponding position in the 3D topographic data 41 may be generated.

Therefore, the 3D topographic data is generated from the 2D image (i.e., the topographic map 40).

Referring back to FIG. 4, in one embodiment, step S11 includes steps S30 to S32.

In step S30: the road network data module 11 receives the road network data from the road network server 21 through the API provided by the road network server 21.

In one embodiment, the road network data includes a plurality of roads. Each of the roads is defined by the global positioning coordinate system, such as the connection among a plurality of GPS coordinates.

In step S31: the road network data module 11 performs a geographical position corresponding process to the road network data and the topographic map based on the global positioning coordinate system and performs a coordinate transformation process and a merging process to add a plurality of road objects of the 3D graphics coordinate system to the 3D topographic data as the 3D route data.

In one embodiment, the coordinate transformation process transforms the road network data from the global positioning coordinate system into the 3D graphics coordinate system of the 3D cartography software.

In one embodiment, the 3D route data includes the plurality of road objects respectively corresponding to the plurality of roads mentioned above.

The merging process superimposes the road network data that is transformed into the 3D graphics coordinate system on the 3D topographic data that uses the same 3D graphics coordinate system to build the plurality of road objects in the 3D topographic data.

It should be noted that the superimposition is performed based on the geographic position. For example, the pixel of the road network data and the pixel of the topographic map that have the same geographic coordinates are superimposed one on another of the same 3D graphics coordinates.

In step S32: the road network data module 11 selects at least one of the pluralities of road objects to be the target route.

In one embodiment, the road network data module 11 accepts one or more setting operations of the target route by selecting one or more road objects. The road network data module 11 tags the selected road object (such as setting a flag on the road object) to set the selected road object as the target route (i.e., the user can move on the route) and set the other road objects as the non-target route (i.e., the user cannot move on the route).

In one embodiment, the user may select one or more target roads through the road network server 21 (e.g., on the operation interface provided by Google Map) to receive the geographical position coordinates of the target roads. Then, the user inputs the geographical position coordinates of the target roads to the road network data module 11, so the road network data module 11 sets the corresponding target route(s) of the 3D route data based on the target roads.

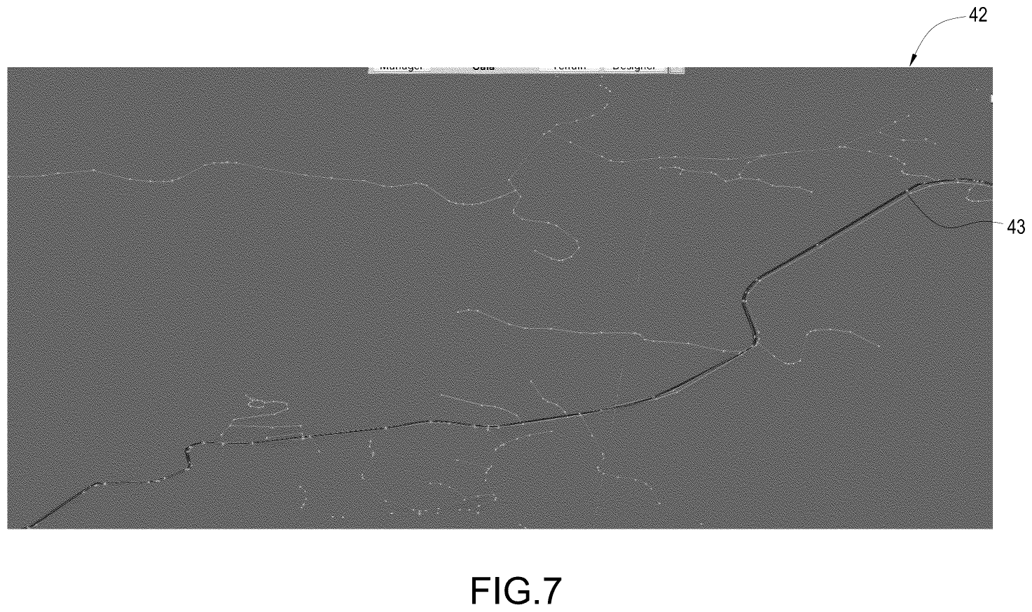

Reference is made to FIG. 7. FIG. 7 illustrates an example of 3D route data in accordance with one embodiment of the present disclosure.

As shown in FIG. 7, the target route 43 (i.e., the black bold line) is set among the plurality of road objects in the 3D route data 42, and the other road objects are set as the non-target route (i.e., the white lines).

Referring back to FIG. 4, in one embodiment, step S12 includes steps S40 to S42.

In step S40: the basic object module 12 receives the landscape data of the global positioning coordinate system from the landscape server 22 through the API provided by the landscape server 22.

In one embodiment, the landscape data includes a plurality of landscapes and stores basic data of each landscape. The basic data of the landscape includes GPS coordinates, landscape ranges, types of landscape, landscape views, and so on.

In one embodiment, the landscape may be but is not limited to artificial landscapes such as buildings, traffic signs, historic sites, ports, and passersby, or natural landscapes such as trees, hills, vegetation, and animals.

In step S41: the basic object module 12 performs the geographical position corresponding process to the landscape data and the road network data based on the global positioning coordinate system and performs the coordinate transformation process and the merging process to add the 3D landscape data along the target route of the 3D graphics coordinate system to the 3D topographic data.

In one embodiment, the coordinate transformation process may transform the landscape data of the global positioning coordinate system to the 3D graphics coordinate system of the 3D cartography software.

In one embodiment, the 3D landscape data includes a plurality of landscape objects respectively corresponding to the plurality of landscapes mentioned above.

The merging process superimposes the landscape data that is transformed into the 3D graphics coordinate system and the 3D topographic data that uses the same 3D graphics coordinate system to generate the plurality of landscape objects in the 3D topographic data.

It should be noted that the superimposition is performed based on the geographic position, such as superimposing pixels of the same geographic coordinates of the landscape data and that of the topographic map onto the same 3D cartography coordinates.

In step S42: the basic object module 12 modifies, adds, or deletes the landscape objects in the 3D landscape data based on the landscape adjusting operation.

In one embodiment, the 3D road scene provider (such as game service providers) may manually adjust the 3D landscape data that is automatically generated (in the landscape adjusting operation), so the existing landscape objects may be modified (such as appearances, positions, sizes, and so on), the landscape object may be added (such as new indicators), or the existing landscape objects may be deleted (such as passersby, street lights).

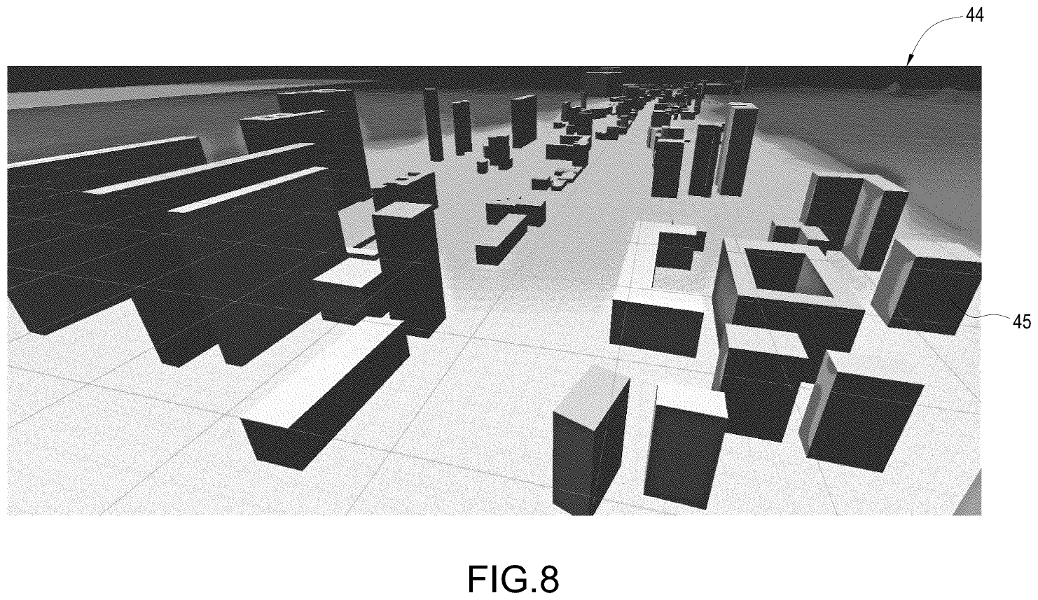

Reference is made to FIG. 8. FIG. 8 illustrates an example of 3D landscape data in accordance with one embodiment of the present disclosure. As shown in FIG. 8, the 3D landscape data 44 includes the plurality of landscape object 45. Each landscape object 45 is disposed on different 3D cartography coordinates.

Referring back to FIG. 4, in one embodiment, step S13 includes steps S50 to S51.

In the embodiment, the coordinate transformation process and the merging process provided in steps S21, S31, and S41 may be performed by the integration module 13.

In step S50: the integration module 13 performs the coordinate transformation process to transform the topographic map, the road network data, and the landscape data of the global positioning coordinate system onto the 3D topographic data, the 3D route data, and the 3D landscape data of the 3D graphics coordinate system.

In step S51: the integration module 13 performs the merging process to merge the 3D topographic data, the 3D route data, and the 3D landscape data of the 3D graphics coordinate system to generate the 3D road scene data.

For example, the integration module 13 first aligns the 3D topographic data, the 3D route data, and the 3D landscape data in accordance with the global positioning coordinate system, then performs the coordinated transformation process to align the 3D topographic data, the 3D route data, and the 3D landscape data on the 3D graphics coordinate system, and then performs the merging process to merge the 3D topographic data, the 3D route data, and the 3D landscape data whose coordinates have been aligned in the same coordinate system to be the 3D road scene data.

In one embodiment, step S13 includes steps S52 to S53.

In step S52: the integration module 13 automatically modifies, adds, or deletes the plurality of objects of the 3D road scene data automatically generated based on a visual adjusting process.

In one embodiment, the 3D road scene provider may manually adjust the 3D road scene data that is automatically generated to modify, add, or delete the objects (such as street objects, landscape objects, and terrain heights) in the 3D road scene data.

For example, the visual adjusting process includes modifying the street object to satisfy the terrain heights, adding the landscape object (such as tree objects, famous spots, and famous landscapes), and deleting the landscape object (such as passersby and traffic cones).

For another example, the visual adjusting process includes adding tunnel objects, bridge objects, elevated road objects, and the like when the terrain height is different from the height of the street object, so the configuration of the street object satisfies the configuration logic.

In one embodiment, the target route includes a plurality of intersection points, and each intersection point connects to the plurality of road objects and has a flag. The user may select any combination of the intersection points in the game to change the target route in real-time.

In one embodiment, the user may select the intersection points before the game starts, and only the selected routes corresponding to the selected intersection points are applied for the user to move in the game (the target routes), and the rest routes corresponding to non-selected intersection points remain forbidden (non-target routes).

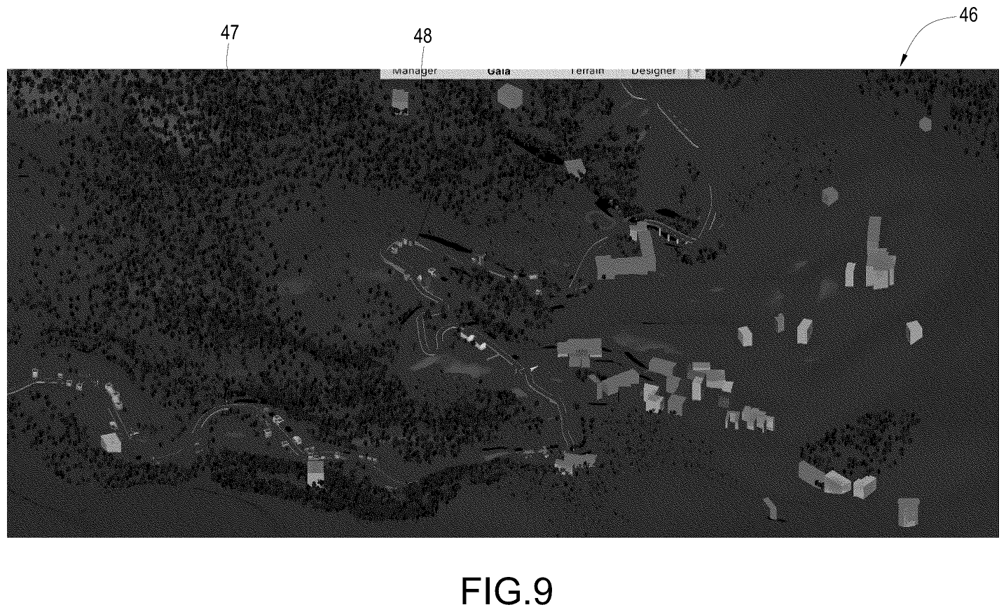

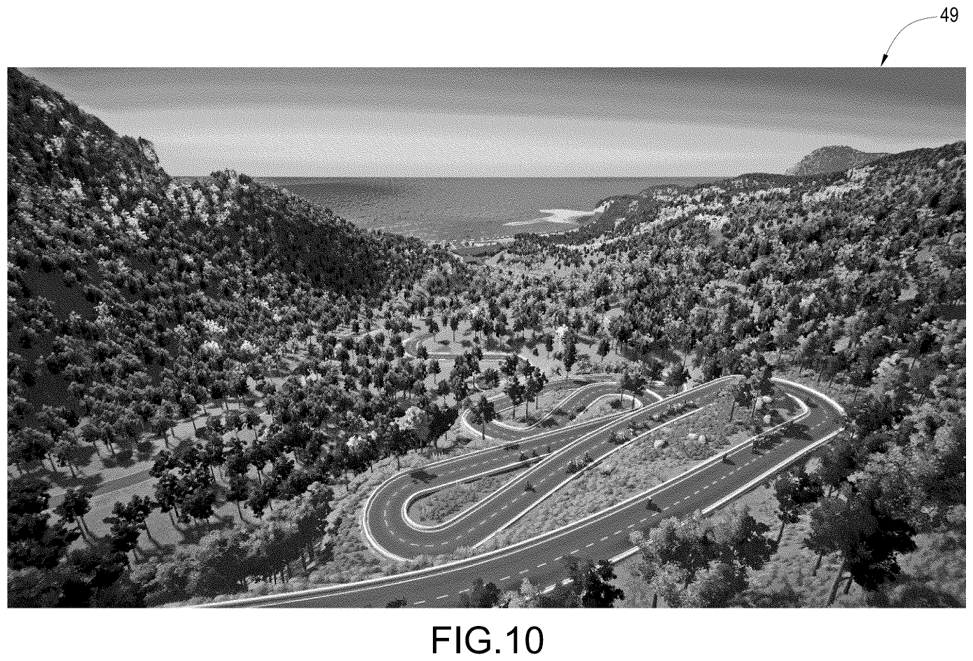

Reference is made to FIG. 9 and FIG. 10. FIG. 9 illustrates an example of 3D road scene data in accordance with one embodiment of the present disclosure. FIG. 10 illustrates an example of the 3D road scene data after adjusting in accordance with one embodiment of the present disclosure.

As shown in FIG. 9, the 3D road scene data 46 includes a large amount of landscape object 47 and road object 48, however, the visual effect of the objects are not delicate enough.

For the problem above, the 3D road scene provider may manually adjust the visual presentation, and another 3D road scene data 49 as shown in FIG. 10 is obtained after adjusting.

As shown in FIG. 10, the adjusted 3D road scene data 49 is presented with a delicate visual effect, so the user experience is improved.

Referring back to FIG. 4, in step S53: the integration module 13 releases the 3D road scene data being adjusted to the 3D road scene server 21.

Accordingly, the present disclosure has to only capture the gray 2D topographic map (the gray scale of the gray image indicates the height) and receive the road network data and the landscape data of the GPS coordinate system, the 3D road scene generation system generates the 3D topographic data, the 3D route data, and the 3D landscape data of the 3D graphics coordinate system, and the 3D road scene generation system superimposes 3D topographic data, the 3D route data, and the 3D landscape data to obtain the 3D road scene data of the coordinated 3D graphics coordinate system. When the user operates the client computer device, the 3D road scene generation system transforms the 3D road scene data along the target route that the user moves along, such that the client computer device presents the terrain changes and scenery along the target route without shooting real environment films or making 3D simulated movies in advance. The 3D road scene generation system automatically provides the terrain height changes and road scene changes associated with the physical location. Therefore, the production complexity and cost of building the 3D road scene data is reduced.

The present disclosure provides the 3D road scene generation system and the 3D road scene generation method for simulating a real environment to automatically generate the 3D road scenes of the simulated real environment and provide the users with the immersive experience as if they were moving in the real environment.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A 3D road scene generation system (1) for simulating a real environment, comprising:
a terrain feature module (10), configured to generate 3D topographic data (41) of a target area based on a topographic map (40) received from a terrain server (20);
a road network data module (11), configured to generate 3D route data (42) of the target area based on road network data (42) received from a road network server (21), wherein the 3D route data (42) comprises a target route (43) of the target area:
a basic object module (12), configured to generate 3D landscape data (44) of the target area based on landscape data received from a landscape server (22); and
an integration module (13), configured to perform an integrating process to the 3D topographic data (41), the 3D route data (42), and the 3D landscape data (44) to generate 3D road scene data (46, 49), wherein the 3D road scene data (46, 49) is configured to present terrain changes and scenery along the target route (43).

2. The 3D road scene generation system (1) of claim 1, further comprising:
a first subsystem (30), connected to a network (33), comprising the terrain feature module (10);
a second subsystem (30), connected to the network (33), comprising the road network data module (11):
a third subsystem (30), connected to the network (33), comprising the basic object module (12); and
a fourth subsystem (30), connected to the network (33), comprising the integration module (13).

3. The 3D road scene generation system (1) of claim 1, further comprising:
a 3D road scene server (31), connected to a network (33) and storing a plurality of default 3D road scene data of a plurality of default areas, and configured to receive a road scene request for any one of the default areas from a client computer device (32) to transmit a corresponding one of the default 3D road scene data of the default area being requested through the network (33) to the client computer device (32) as the 3D road scene data (46, 49) of the target area:
wherein each of the plurality of default 3D road scene data comprises a plurality of 3D grids, and the plurality of 3D grids respectively correspond to a plurality of sub-areas of the default area.

4. The 3D road scene generation system (1) of claim 1, wherein the terrain feature module (10) is configured to receive a 2D gray image from the terrain server (20) as the topographic map (40), perform a 3D transformation process to the topographic map (40) to generate a plurality of heights corresponding to a plurality of values of a plurality of pixels on a plurality of positions of the 3D topographic data (41) corresponding to the plurality of pixels of the topographic map (40), and generate the 3D topographic data (41) of a 3D graphics coordinate system:
wherein the road network data module (11) is configured to receive the road network data of a plurality of roads of a global positioning coordinate system from the road network server (21), perform a geographical position corresponding process to the road network data and the topographic map (40) based on the global positioning coordinate system, perform a coordinate transformation process and a merging process to add a plurality of road objects (48) to the 3D topographic data (41) based on the 3D graphics coordinate system to be the 3D route data (42), and select at least one of the plurality of road objects (48) as the target route (43);
wherein the basic object module (12) is configured to receive the landscape data of the global positioning coordinate system from the landscape server (22), perform the geographical position corresponding process to the landscape data and the road network data based on the global positioning coordinate system, perform the coordinate transformation process and the merging process to add the 3D landscape data (44) of the 3D graphics coordinate system along the target route (43) to the 3D topographic data (41), and modify, add, or delete a landscape object (45) of the 3D landscape data (44) by a landscape adjusting operation.

5. The 3D road scene generation system (1) of claim 1, wherein the integration module (13) is configured to perform a coordinate transformation process to obtain the 3D topographic data (41), the 3D route data (42), and the 3D landscape data (44) of the 3D graphics coordinate system, and perform a merging process to merge the 3D topographic data (41), the 3D route data (42), and the 3D landscape data (44) of the 3D graphics coordinate system to be the 3D road scene data (46, 49);
wherein the integration module (13) is configured to modify, add, or delete a plurality of objects of the 3D road scene data based on a visual adjusting process and release the 3D road scene data to a 3D road scene server (31).

6. A 3D road scene generation method for simulating a real environment, comprising:
a) generating 3D topographic data (41) of a target area based on a topographic map (40) received from a terrain server (20);
b) generating 3D route data (42) of the target area based on road network data received from a road network server (21), wherein the 3D route data (42) comprises a target route (43) of the target area:
c) generating 3D landscape data (44) of the target area based on landscape data received from a landscape server (22): and d) performing an integrating process to the 3D topographic data (41), the 3D route data (42), and the 3D landscape data (44) to generate 3D road scene data (46, 49), wherein the 3D road scene data (46, 49) is used to present terrain changes and scenery along the target route (43).

7. The 3D road scene generation method of claim 6, wherein a) further comprises:
a1) receiving the topographic map (40) from the terrain server (20), wherein the topographic map (40) is a 2D gray image and a plurality of values of a plurality of pixels of the topographic map (40) indicates heights: and a2) perform a 3D transformation process to the topographic map (40) to generate a plurality of heights corresponding to the plurality of values on a plurality of positions of the 3D topographic data (41) corresponding to the plurality of pixels, and generate the 3D topographic data (41) of a 3D graphics coordinate system.

8. The 3D road scene generation method of claim 6, wherein b) comprises:
b1) receiving the road network data from the road network server (21), wherein the road network data comprises a plurality of roads of a global positioning coordinate system:
b2) performing a geographical position corresponding process to the road network data and the topographic map (40) based on the global positioning coordinate system, performing a coordinate transformation process and a merging process to add a plurality of road objects (48) of the 3D graphics coordinate system to the 3D topographic data (41) to be the 3D route data (42); and
b3) selecting at least one of the pluralities of road objects (48) as the target route (43).

9. The 3D road scene generation method of claim 6, wherein c) comprises:
c1) receiving the landscape data of the global positioning coordinate system from the landscape server (22):
c2) performing the geographical position corresponding process to the landscape data and the road network data based on the global positioning coordinate system, and performing the coordinate transformation process and the merging process to add the 3D landscape data (44) of the 3D graphics coordinate system along the target route (43) to the 3D topographic data (41); and
c3) modifying, adding, or deleting a landscape object of the 3D landscape data (44) by a landscape adjusting operation.

10. The 3D road scene generation method of claim 6, wherein d) comprises:
d1) performing a coordinate transformation process to obtain the 3D topographic data (41), the 3D route data (42), and the 3D landscape data (44) of the 3D graphics coordinate system:
d2) performing a merging process to merge the 3D topographic data (41), the 3D route data (42). and the 3D landscape data (44) of the 3D graphics coordinate system to be the 3D road scene data (46. 49):
d3) modifying. adding. or deleting a plurality of objects of the 3D road scene data (46. 49) based on a visual adjusting process: and d4) release the 3D road scene data (46. 49).
